(19) United States
(12) Patent Application Publication
(10) Pub. No.: US 2003/0198804 A1
(43) Pub. Date: Oct. 23, 2003

(54) GLASS FIBER FABRIC WALLPAPER

(76) Inventor: NIELS WENDLAND, BAD SOODEN-ALLENDORF (DE)

Correspondence Address: THOMAS C PONTANI, COHEN PONTANI LIEBERMAN & PAVANE, 551 FIFTH AVENUE, SUITE 1210, NEW YORK, NY, 10176

(21) Appl. No.: 09/269,771

(22) PCT Filed: Sep. 5, 1997
(86) PCT No.: PCT/EP97/04817

(30) Foreign Application Priority Data
Oct. 1, 1996 (DE) 19640624.2

(51) Int. Cl. B32B 17/02; B32B 17/04; D03D 15/00

(52) U.S. Cl. 428/343; 442/181

(57) ABSTRACT

The invention relates to a glass fiber fabric wallpaper with a flat glass fiber fabric, which has a layer of a thermoplastic permanent adhesive on one of its sides. Said adhesive is made preferably of water-insoluble bonding-melt adhesive or a hot-melt-type adhesive, which, after being treated thermally on one of its side, adheres permanently once it cools off. The adhesive is applied in the usual way, e.g. by scrapping or by rolling. A removable paper foil can be placed on the adhesive layer. The glass fiber fabric is substantially adhesive-proof.

The invention relates to a glass fiber fabric wallpaper.

Glass fiber fabric wallpapers are known that are provided on the reverse with an adhesive, which is applied as an aqueous dispersion. This permits initial adhesion when the glass fiber fabric wallpaper is mounted on a firm and dry substrate. Ultimate fixing of the glass fiber fabric wallpaper on the wall, however, requires a special adhesive paint which must be applied shortly after mounting to the side of the glass fiber fabric wallpaper facing away from the wall. Otherwise, the self-attaching glass fiber fabric wallpaper would within a short period become detached from the wall again.

A disadvantage with this self-attaching glass fiber fabric wallpaper is that, on the one hand, a special adhesive paint is necessary, so that wallpapering and painting is laborious and expensive. On the other hand, the fabric of the layer of glass fiber fabric wallpaper needs a particularly open structure so that the adhesive is able to penetrate the glass fiber fabric wallpaper in order to allow the glass fiber fabric wallpaper to be fixed to the wall.

DD-A-133 692 discloses a glass fiber fabric wallpaper which is provided on one side with an adhesive layer which must be moistened before the glass fiber fabric wallpaper is mounted on the wall, since the adhesive is soluble in water and is tacky only in the moist state. As with a conventional glass fiber fabric wallpaper, there is the disadvantage that after initial bonding the glass fiber fabric wallpaper must dry out before it can be coated.

The technical problem on which the present invention is based, then, is to develop and configure the known glass fiber fabric wallpaper in such a way that wallpapering can be carried out more effectively and more rapidly.

The above-described problem is solved in accordance with the invention by a glass fiber fabric wallpaper which is provided on one side with a thermoplastic long-term adhesive. The long-term adhesive consists preferably of a water-insoluble hot melt or pressure-sensitive hot melt adhesive.

These are available commercially and are described, for example, in Römpp Chemie-Lexikon, page 4037. Examples of suitable hot melt adhesives are “Helmitherm 42034” from Forbo-Helmitin GmbH, Pirmasens, “Tivolmelt 9058/30”, “Tivomelt 9041” and “Tivomelt 9162” from Tivoli Werke AG, Hamburg, and “Technomelt Q 5304” from Henkel KGaA, Dusseldorf. The ductile pressure-sensitive hot melt adhesives feature particularly long bond times, contain no hazardous ingredients, and are not self-igniting. They may also undergo post-crosslinking. The long-term adhesive is applied by heat treatment to one side of the glass fiber fabric and after cooling is permanently tacky.

The adhesive is applied in conventional manner, for example, by applying the adhesive melt by knife coater or rollers, so that the adhesive adheres only in dots at the raised points of the fabric. In respect of the amount and degree of fluidization, especially of the hot melt adhesive, the application process is designed so that no adhesive penetrates the glass fiber fabric and contaminates the glass fiber fabric wallpaper surface that is to be coated with paint, if desired. This is additionally assisted by the structure of the glass fiber fabric. Therefore, it is also possible to pretreat the glass fiber fabric wallpaper surface facing away from the wall so that after the glass fiber fabric wallpaper has been mounted it can be painted immediately without priming beforehand. This property as well leads to an acceleration and simplification of the wallpapering and painting operation.

The self-adhesive glass fiber fabric wallpaper of the invention can also be sold in rolls in the manner customary for glass fiber fabric wallpapers; in that case, if necessary, contamination of the facing side or sticking to itself can be prevented by means of a release film which is made, for example, of polyethylene and is easily removable prior to use, or by means of a release paper, on the adhesive reverse of the wallpaper.

In contrast to the known self-attaching glass fiber fabric wallpapers the glass fiber fabric wallpaper of the invention is self-adhesive, i.e., it can be mounted on the wall without the use of an additional adhesive. The interrupted layer of thermoplastic long-term adhesive brings about durable fixing which by virtue of subsequent additional crosslinking, indeed, produces an increasingly stronger connection between the glass fiber fabric wallpaper and the wall.

In comparison to the self-attaching glass fiber fabric wallpapers known from the prior art, the self-adhesive glass fiber fabric wallpaper has a range of advantages. First of all, treating the surface of the wall beforehand is unnecessary; existing wallpapers, provided they themselves are still attached well to the wall, can be used as a substrate for the new self-adhesive glass fiber fabric wallpaper. Following the mounting of the glass fiber fabric wallpaper it can be painted immediately on the side facing into the room, since it is not necessary to wait until the long-term adhesive has dried. Therefore, the effort of applying an adhesive to the reverse of the glass fiber fabric wallpaper is done away with, and there is no time delay between mounting and painting the glass fiber fabric wallpaper. Removal from the wall is readily possible because the affinity of the adhesive to the wallpaper is higher than to the substrate.

1. A glass fiber fabric wallpaper comprising a two-dimensional glass fiber fabric, wherein for the purpose of more effective and more rapid wallpapering said glass fiber fabric is provided on one side with a layer of a thermoplastic long-term adhesive in such a way that no long-term adhesive penetrates the glass fiber fabric and contaminates the glass fiber fabric surface that is not provided with long-term adhesive.

2. The glass fiber fabric wallpaper as claimed in claim 1, wherein the long-term adhesive is insoluble in water.

3. The glass fiber fabric wallpaper as claimed in claim 1 or 2, wherein the long-term adhesive is a pressure-sensitive hot melt adhesive.

4. The glass fiber fabric wallpaper as claimed in one of claims 1 to 3, wherein said glass fiber fabric is essentially impermeable to adhesive.

5. The glass fiber fabric wallpaper as claimed in one of claims 1 to 4, comprising an interrupted layer of the long-term adhesive.

6. The glass fiber fabric wallpaper as claimed in one of claims 1 to 5, comprising a removable release film on the adhesive layer.
